(19) United States
(12) Patent Application Publication
(10) Pub. No.: US 2026/0195354 A1
(43) Pub. Date: Jul. 9, 2026

(54) CONVERSATIONAL RECOMMENDATIONS OF VIRTUAL EXPERIENCES

(71) Applicant: Roblox Corporation, San Mateo, CA (US)

(72) Inventors: Zheng HUI, San Mateo, CA (US); Xiaokai WEI, San Mateo, CA (US); Yexi JIANG, San Mateo, CA (US); Kevin GAO, San Mateo, CA (US); Chen WANG, San Mateo, CA (US); Frank ONG, San Mateo, CA (US); Se-eun YOON, San Mateo, CA (US); Rachit PAREEK, San Mateo, CA (US); Xiaohong GONG, Sunnyvale, CA (US)

(73) Assignee: Roblox Corporation, San Mateo, CA (US)

(21) Appl. No.: 19/443,850

(22) Filed: Jan. 8, 2026

Related U.S. Application Data
(60) Provisional application No. 63/743,598, filed on Jan. 9, 2025.

(51) Int. Cl. G06F 16/3329; G06F 16/338; G06F 40/30

(52) U.S. Cl. CPC G06F 16/33295; G06F 16/338; G06F 40/30

(57) ABSTRACT

Various implementations relate to methods, systems, and computer readable media for providing conversational recommendations of virtual experiences within a virtual platform. According to one aspect, a computer-implemented method includes obtaining a natural language input from a user comprising a request for a recommendation of virtual experiences, analyzing the natural language input to determine a user intent and a plurality of user preferences, and generating a set of candidate recommendations based on the user intent and the plurality of user preferences. A ranking of the set of candidate recommendations is generated using weighted aggregation of evaluation metrics produced by a plurality of AI models. A set of refined recommendations is generated by modifying the ranking using a plurality of contextual cues across the plurality of AI models, and the set of refined recommendations is transmitted to the user.

### CROSS-REFERENCE TO RELATED APPLICATIONS

This application claims priority to U.S. Provisional Patent Application No. 63/743,598, filed Jan. 9, 2025, and titled “CONVERSATIONAL RECOMMENDATIONS OF VIRTUAL EXPERIENCES,” the entire contents of which are incorporated by reference herein.

### TECHNICAL FIELD

Various implementations described herein relate generally to conversational recommendations, and more particularly but not exclusively, to methods, systems, and computer-readable media to provide personalized conversational recommendations of virtual experiences within a virtual platform.

### BACKGROUND

Conversational recommendation techniques assist users in discovering content within large and dynamic virtual platforms. These techniques rely on natural language input, e.g., in a conversational interface such as chat, to infer user interests and provide suggested virtual experiences in response to the natural language input. As the number and variety of available virtual experiences at a virtual platform grows, accurately interpreting user intent and mapping that intent to relevant content becomes more challenging. Approaches that rely on predefined rules, keyword matching, or static preference profiles, are limited in their ability to capture nuanced, evolving user interests expressed through free-form conversation.

Some recent approaches incorporate machine-learned language models to process conversational input and generate recommendations. While these approaches can improve query understanding of natural language input, they are implemented using a single model. Such designs tend to emphasize popularity signals or coarse similarity measures, which can result in recommendations that are repetitive, overly generic, or disproportionately recommend well-known experiences. These approaches struggle to balance competing objectives such as relevance, novelty, and diversity, particularly when user preferences are implicit or context-dependent.

Another shortcoming of existing conversational recommendation techniques relates to trust, safety, and transparency. Users are provided with recommendations without insight into why particular experiences were selected. The lack of explanatory context can reduce user confidence and engagement with the recommendations. Additionally, conversational interfaces are susceptible to adversarial or manipulative inputs, including attempts to bypass content restrictions or influence recommendation outputs. Existing techniques lack robust safeguards against such inputs, increasing the risk of unsafe or unreliable recommendations.

Efforts to address these limitations have included ensemble-based ranking, modular pipelines, and agent-based coordination. The approaches introduce additional complexity without effective coordination between components. In practice, different machine learning models or other components may operate independently, leading to inconsistent scoring, redundant computation, or conflicting outputs.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Various implementations described herein relate to methods, systems, and computer-readable media to provide personalized conversational recommendations of virtual experiences within a virtual platform.

According to one aspect, a computer-implemented method includes obtaining a natural language input from a user, the natural language input including a request for a recommendation of virtual experiences within a virtual platform. The natural language input is analyzed to determine a user intent and a number of user preferences. A set of candidate recommendations is generated based on the user intent and the number of user preferences. A ranking of the set of candidate recommendations is generated using weighted aggregation of evaluation metrics produced by a number of artificial intelligence (AI) models. A set of refined recommendations is generated by modifying the ranking of the set of candidate recommendations using a plurality of contextual cues across the number of AI models. The set of refined recommendations is transmitted to the user.

In some implementations, prior to analyzing the natural language input, it is detected, using a jailbreak prevention mechanism, that the natural language input includes adversarial content, where the jailbreak prevention mechanism includes randomized token dropping and semantic intent analysis. In response to determining that the natural language input includes the adversarial content, a security operation is performed with respect to the natural language input, wherein the analyzing, generating the set of candidate recommendations, generating the ranking, generating the set of refined recommendations, and transmitting are not performed.

In some implementations, one or more explanations for one or more recommendations in the set of refined recommendations are generated via at least a subset of the number of AI models. The one or more explanations are transmitted to the user.

In some implementations, generating the one or more explanations includes identifying and assembling justification signals that describe alignment between individual recommendations and at least one of: the user intent, the plurality of user preferences, or prior interaction data associated with the user.

In some implementations, the generated one or more explanations are evaluated using an automated explanation assessment that computes explanation quality scores prior to transmitting the one or more explanations to the user, where at least one explanation associated with an explanation quality score that fails to meet a threshold is excluded from the transmitting.

In some implementations, the ranking of the set of candidate recommendations is based on one or more of the following: relevance, novelty, diversity, and user-specific constraints.

In some implementations, analyzing the natural language input, generating the set of candidate recommendations, generating the ranking, and generating the set of refined recommendations are performed by a number of cooperating agents, where each of the number of cooperating agents is configured to execute a different one of the analyzing, generating, ranking, or refining operations.

In some implementations, the number of AI models include a number of large language models (LLMs).

In some implementations, generating the set of candidate recommendations includes invoking a number of external tools via application programming interfaces to retrieve platform data of the virtual platform associated with the virtual experiences.

In some implementations, the weighted aggregation of evaluation metrics includes assigning model-specific weights based on historical evaluation performance of the number of AI models.

In some implementations, generating the set of refined recommendations includes re-evaluating a subset of higher-ranked candidate recommendations using additional contextual attributes, the additional contextual attributes including metadata associated with the virtual experiences represented by the candidate recommendations and preference signals inferred from the natural language input and prior user interactions.

According to another aspect, a computing device includes one or more processors, and memory coupled to the one or more processors with instructions stored thereon that, when executed by the one or more processors, cause the one or more processors to perform operations including obtaining a natural language input from a user, the natural language input including a request for a recommendation of virtual experiences within a virtual platform. The natural language input is analyzed to determine a user intent and a number of user preferences. A set of candidate recommendations is generated based on the user intent and the number of user preferences. A ranking of the set of candidate recommendations is generated using weighted aggregation of evaluation metrics produced by a number of AI models. A set of refined recommendations is generated by modifying the ranking of the set of candidate recommendations using a plurality of contextual cues across the number of AI models. The set of refined recommendations is transmitted to the user.

In some implementations, prior to analyzing the natural language input, it is detected, using a jailbreak prevention mechanism, that the natural language input includes adversarial content, where the jailbreak prevention mechanism includes randomized token dropping and semantic intent analysis. In response to determining that the natural language input includes the adversarial content, a security operation is performed with respect to the natural language input, wherein the analyzing, generating the set of candidate recommendations, generating the ranking, generating the set of refined recommendations, and transmitting are not performed.

In some implementations, one or more explanations for one or more recommendations in the set of refined recommendations are generated via at least a subset of the number of AI models. The one or more explanations are transmitted to the user.

In some implementations, generating the one or more explanations includes identifying and assembling justification signals that describe alignment between individual recommendations and at least one of: the user intent, the plurality of user preferences, or prior interaction data associated with the user.

In some implementations, the generated one or more explanations are evaluated using an automated explanation assessment that computes explanation quality scores prior to transmitting the one or more explanations to the user, where at least one explanation associated with an explanation quality score that fails to meet a threshold is excluded from the transmitting.

In some implementations, the ranking of the set of candidate recommendations is based on one or more of the following: relevance, novelty, diversity, and user-specific constraints.

In some implementations, analyzing the natural language input, generating the set of candidate recommendations, generating the ranking, and generating the set of refined recommendations are performed by a number of cooperating agents, where each of the number of cooperating agents is configured to execute a different one of the analyzing, generating, ranking, or refining operations.

In some implementations, the number of AI models include a number of large language models (LLMs).

According to another aspect, a non-transitory computer-readable medium includes instructions stored thereon that, when executed by a processor, cause the processor to perform operations including obtaining a natural language input from a user, the natural language input including a request for a recommendation of virtual experiences within a virtual platform. The natural language input is analyzed to determine a user intent and a number of user preferences. A set of candidate recommendations is generated based on the user intent and the number of user preferences. A ranking of the set of candidate recommendations is generated using weighted aggregation of evaluation metrics produced by a number of AI models. A set of refined recommendations is generated by modifying the ranking of the set of candidate recommendations using a plurality of contextual cues across the number of AI models. The set of refined recommendations is transmitted to the user.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of the disclosure.

### BRIEF DESCRIPTION OF THE DRAWINGS

FIG. 1 is a diagram of an example system architecture to provide conversational recommendations of virtual experiences, in accordance with some implementations.

FIG. 2 is a flow diagram illustrating an example method to provide personalized conversational recommendations of virtual experiences within a virtual platform, in accordance with some implementations.

FIG. 3 is a diagram illustrating an example user interaction for providing conversational recommendations of virtual experiences within a virtual platform, in accordance with some implementations.

FIG. 4 is a diagram illustrating an example presentation of refined recommendations and associated explanation content within a conversational recommendation interface, in accordance with some implementations.

FIG. 5 is a block diagram that illustrates an example computing device, in accordance with some implementations.

### DETAILED DESCRIPTION

Various implementations described herein relate to techniques to generate conversational recommendations of virtual experiences within a virtual platform using coordinated artificial intelligence (AI) components. The techniques operate on natural language input provided by a user and infer user intent and preferences from conversational context. Based on the analysis, candidate virtual experiences are identified and prepared for further evaluation. The overall approach is designed to operate in environments that include large and evolving collections of virtual experiences.

In some implementations, candidate recommendations are evaluated using multiple AI models that independently produce evaluation outputs. These outputs are combined through weighted aggregation to generate an initial ranking of the candidate recommendations. The aggregation enables multiple evaluation perspectives to be incorporated, enabling the ranking to reflect a combination of relevance signals and preference alignment rather than reliance on a single scoring source.

In some implementations, the ranking is further refined using contextual cues derived from user interaction history, content metadata, and/or conversational context. The refinement enables adjustments to the ranking that account for nuanced user interests and platform-specific considerations. The refined recommendations are generated in a manner that adapts dynamically to changes in user input and available content.

In some implementations, the techniques include safeguards against adversarial or manipulative conversational inputs and generate explanatory information associated with recommended virtual experiences. Explanations provide insight into how recommendations relate to user intent and preferences, supporting transparency and user trust. The refined recommendations and associated explanations are provided to the user through a conversational interface within the virtual platform.

Technical advantages of various features described herein include improved recommendation accuracy (e.g., fit and responsiveness to natural language input), variety (e.g., diversity of recommendations from available virtual experiences), and robustness (e.g., reliable performance of recommendations in terms of likelihood of user acceptance) through coordinated use of multiple AI models. By aggregating evaluation metrics produced by different models, the techniques reduce dependence on any single model bias or failure mode. The aggregation enables stable ranking behavior across varying user inputs and content distributions, which is particularly important in large virtual platforms with heterogeneous content and rapidly changing inventories, e.g., of virtual experiences.

Another technical advantage of some implementations is improved handling of complex and ambiguous natural language input. By analyzing conversational input across multiple cooperating agents, the techniques enable separation of intent inference, preference extraction, ranking evaluation, and refinement processing. The decomposition enables each stage to focus on a well-defined computational task, resulting in reliable interpretation of user requests, and alignment between inferred preferences and recommended virtual experiences.

Another technical advantage of some implementations is enhanced adaptability to dynamic contextual signals. The refinement of candidate rankings using contextual cues enables recommendations to be adjusted based on interaction history, conversational state, and/or content metadata without retraining underlying AI models. This reduces computational overhead and latency associated with model updates while still enabling real time adaptation to evolving user behavior and platform conditions.

Another technical advantage of some implementations is safety and operational resilience through integrated jailbreak prevention. Detecting adversarial content using semantic intent analysis and randomized token manipulation reduces the risk of unsafe outputs and manipulation of recommendation behavior. This improves reliability of conversational interfaces and reduces downstream moderation or correction costs associated with unsafe or unintended outputs.

Another technical advantage of some implementations is improved transparency and debuggability of recommendation behavior. Generating explanations tied to user intent, preferences, and ranking factors provides structured insight into why specific virtual experiences are recommended. This enables auditing, tuning, and evaluation of recommendation performance while supporting user trust and informed interaction within the virtual platform.

In the following detailed description, reference is made to the accompanying drawings, which form a part hereof. In the drawings, similar symbols identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation”, “an implementation”, “an example implementation”, “some implementations”, “aspect”, “aspects”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

### System Architecture

The present disclosure is directed towards, inter alia, techniques to provide personalized and trustworthy conversational recommendations for virtual experiences by coordinating multiple artificial intelligence agents, aggregating evaluation metrics produced by multiple AI models, and refining candidate recommendations using contextual cues, while incorporating jailbreak prevention mechanisms to promote safety, reliability, and transparency.

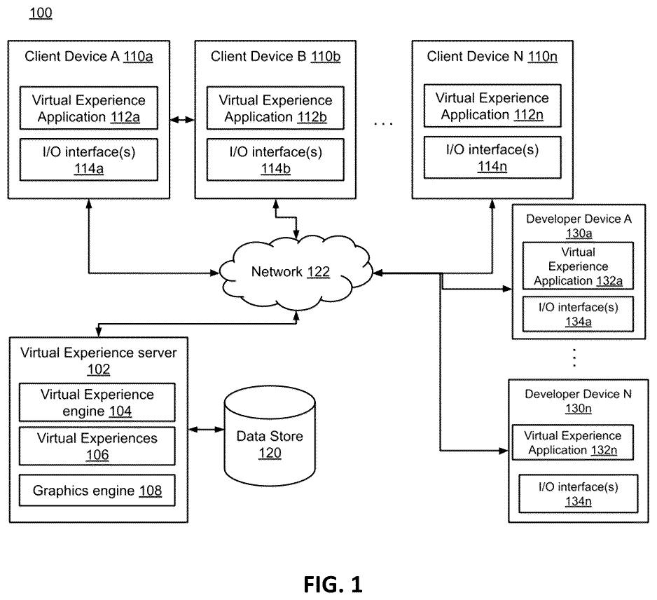

FIG. 1 is a diagram of an example system architecture to provide conversational recommendations of virtual experiences. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client device(s) 110 and developer device(s) 130 may refer to the same or same type of device.

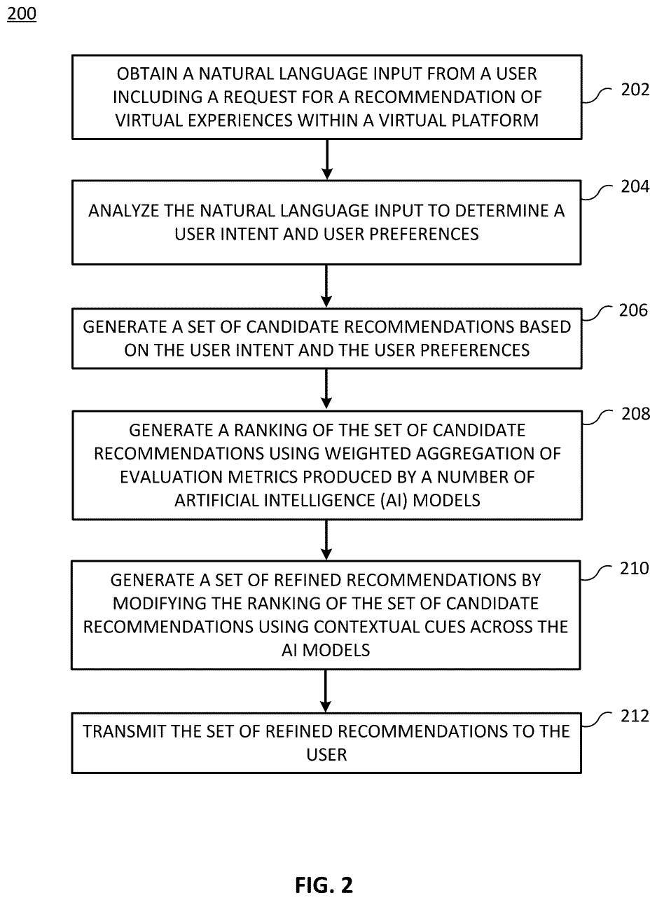

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 may perform one or more of the operations described below in connection with the flowchart shown in FIG. 2. In one or more additional or alternative implementations, the operations described below may be performed on one or more client devices 110, or one or more developer devices 130. In some implementations, where the operations are performed depends at least in part on computational resources, e.g., memory, processing power, or disk space. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may include multiple storage components (e.g., multiple drives or multiple databases) that may span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that enables users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations of the disclosure, a “user” may be represented as a single individual. Other implementations of the disclosure may include a “user” (e.g., creating user) being an entity controlled by a set of users or an automated source. For example, a set of individual users federated as a community or group in a user-generated content system may be considered a “user.”

In some implementations, online virtual experience server 102 may be or include a virtual gaming server. For example, the gaming server may provide single-player or multiplayer games to a community of users that may access a “system” herein that includes online gaming server 102, data store 120, and client device 110 and/or may interact with virtual experiences using client devices 110 via network 122. In some implementations, virtual experiences (including virtual realms or worlds, virtual games, other computer-simulated environments) may be 2D virtual experiences, 3D virtual experiences (e.g., 3D user-generated virtual experiences), virtual reality (VR) experiences, augmented reality (AR) experiences, or combinations thereof, for example. In some implementations, users may participate in interactions (such as gameplay) with other users. In some implementations, a virtual experience may be experienced in real-time or near-real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments”, “virtual environments”, or “virtual spaces” herein) where multiple environments may be linked. An example of a virtual environment may be a three-dimensional (3D) environment. The one or more environments of a virtual experience 106 may be collectively referred to as a “world” or “virtual experience world” or “gaming world” or “virtual world” or “virtual space” or “universe” herein. An example of a world may be a 3D world of a virtual experience 106. For example, a user may build a virtual environment that is linked to another virtual environment created by another user. A character (avatar) of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters (avatars), decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience applications 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. Virtual experience engine 104 implements the techniques described herein. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 meets a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or avatar position and velocity information, etc.) to the online virtual experience server 102. Subsequent to receiving control instructions from the client devices 110, the online virtual experience server 102 may send experience instructions (e.g., position and velocity information of the avatars participating in the group experience or commands, such as rendering commands, collision commands, etc.) to the client devices 110 based on control instructions. For example, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a character (i.e., avatar) of the user within the virtual experience. For example, control instructions may include user input to control action within the experience, such as right, left, up, down, user selection, gyroscope position and orientation data, force sensor data, etc. The control instructions may include avatar position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, avatars (or virtual experience objects generally) are constructed from components, one or more of which may be selected by the user, that automatically join together to aid the user in editing.

In some implementations, an avatar is implemented as a 3D model and includes a surface representation used to draw the avatar (also known as a skin or mesh) and a hierarchical set of interconnected bones (also known as a skeleton or rig). The rig may be utilized to animate the avatar and to simulate motion and action by the avatar. The 3D model may be represented as a data structure, and one or more parameters of the data structure may be modified to change various properties of the avatar, e.g., dimensions (height, width, girth, etc.); body type; movement style; number/type of body parts; proportion (e.g., shoulder and hip ratio); head size; etc.

One or more avatars (also referred to as a “character” or “model” herein) may be associated with a user where the user may control the avatar to enable an interaction of the user with the virtual experience 106.

In some implementations, an avatar may include components such as body parts (e.g., hair, arms, legs, etc.) and accessories (e.g., t-shirt, glasses, decorative images, tools, etc.). In some implementations, body parts of avatars that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may control the scale (e.g., height, width, or depth) of an avatar or the scale of components of an avatar. In some implementations, the user may control the proportions of an avatar (e.g., blocky, anatomical, etc.). It may be noted that in some implementations, an avatar may not include an avatar virtual experience object (e.g., body parts, etc.) but the user may control the avatar (without the avatar virtual experience object) to enable the interaction of the user with the virtual experience (e.g., a puzzle game where there is no rendered avatar game object, but the user still controls an avatar to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish an avatar of a user for view or use by other users of the online virtual experience server 102. In some implementations, creating, modifying, or customizing avatars, other virtual experience objects, virtual experiences 106, or virtual experience environments may be performed by a user using an I/O interface (e.g., developer interface) and with or without scripting (or with or without an application programming interface (API)). It may be noted that for purposes of illustration, avatars are described as having a humanoid form. It may further be noted that avatars may have any form such as a vehicle, animal, animate or inanimate object, or other creative form.

In some implementations, the online virtual experience server 102 may store avatars created by users in the data store 120. In some implementations, the online virtual experience server 102 maintains an avatar catalog and virtual experience catalog that may be presented to users. In some implementations, the virtual experience catalog includes images of virtual experiences stored on the online virtual experience server 102. In addition, a user may select an avatar (e.g., an avatar created by the user or other user) from the avatar catalog to participate in the chosen virtual experience. The avatar catalog includes images of avatars stored on the online virtual experience server 102. In some implementations, one or more of the avatars in the avatar catalog may have been created or customized by the user. In some implementations, the chosen avatar may have avatar settings defining one or more of the components of the avatar.

In some implementations, an avatar of a user can include a configuration of components, where the configuration and appearance of components and more generally the appearance of the avatar may be defined by avatar settings. In some implementations, the avatar settings of an avatar of a user may at least in part be chosen by the user. In other implementations, a user may choose an avatar with default avatar settings or avatar setting chosen by other users. For example, a user may choose a default avatar from an avatar catalog that has predefined avatar settings, and the user may further customize the default avatar by changing some of the avatar settings (e.g., adding a shirt with a customized logo). The avatar settings may be associated with a particular avatar by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual avatar in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual avatar in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player that is embedded in a web page.

According to aspects of the disclosure, the virtual experience application may be an online virtual experience server application for users to build, create, edit, and upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual avatar in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual avatar in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player that is embedded in a web page.

According to aspects of the disclosure, the virtual experience application 132 may be an online virtual experience server application for users to build, create, edit, and upload content to the online virtual experience server 102 as well as interact with online virtual experience server 102 (e.g., provide and/or engage in virtual experiences 106 hosted by online virtual experience server 102). As such, the virtual experience application may be provided to the client device(s) 110 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more avatars available to participate in one or more virtual experiences 106 of online virtual experience server 102. In some implementations, with credentials, a virtual experience developer may obtain access to virtual experience virtual objects, such as in-platform currency (e.g., virtual currency), avatars, special powers, accessories, which are owned by or associated with other users.

In general, functions described in one implementation as being performed by the online virtual experience server 102 can be performed by the client device(s) 110, or a server, in other implementations if appropriate. In addition, the functionality attributed to a particular component can be performed by different or multiple components operating together. The online virtual experience server 102 can be accessed as a service provided to other systems or devices through suitable application programming interfaces (hereinafter “APIs”), and thus is not limited to use in websites.

In some implementations, a virtual platform server (e.g., virtual experience engine 104) includes a recommendation processing component that executes logic to analyze natural language input and generating conversational recommendations of virtual experiences. The recommendation processing component may perform the techniques described herein, including analyzing natural language input to determine user intent and user preferences, invoking cooperating agents and AI models to generate candidate recommendations, and producing ranked and refined recommendation outputs using weighted aggregation of evaluation metrics and contextual cues. The recommendation processing component may further coordinate explanation generation and jailbreak prevention operations prior to transmitting results. By performing these recommendation, ranking, and refinement operations server-side, conversational recommendations may be generated dynamically while reducing computational requirements on client devices.

Client devices execute a platform application (or a browser or any other application) that transmits natural language input and contextual signals to the server and receives refined recommendations and explanation content in response. In some implementations, the platform application may transmit conversational input, session identifiers, or user interaction signals that guide intent analysis, candidate generation, or contextual refinement. The platform application may cache recommendation results, explanation content, or interaction state for reuse across conversational turns, enabling continuity within an ongoing session. In certain configurations, the client device may perform presentation-layer operations such as ranking, filtering, or rendering recommendation cards and explanation elements based on display constraints or interface capabilities while preserving the recommendation ranking and justification data generated by the server.

### Personalized Conversational Recommendations of Virtual Experiences

FIG. 2 is a flow diagram illustrating an example method 200 to provide personalized conversational recommendations of virtual experiences within a virtual platform, in accordance with some implementations.

In various implementations, the blocks shown in FIG. 2 and described below may be performed by any of the computing devices illustrated in FIG. 1, for example, by one or more of client devices 110 and/or online virtual experience server 102. For example, two or more client devices 110 may perform method 200, or at least one client device 110 and online virtual experience server 102 may perform method 200. In some implementations, certain blocks of method 200 may be performed by a client device 110 and other blocks of method 200 may be performed by an online virtual experience server 102.

Method 200 begins at block 202. At block 202, natural language input is obtained from a user, e.g., via a conversational user interface such as chat, as audio input. The natural language input includes a request for a recommendation of virtual experiences within a virtual platform. As used herein, a natural language input includes input expressed in human-readable linguistic form rather than a predefined command syntax. The natural language input may include one or more words, phrases, sentences, or conversational turns expressed in spoken or written form. Examples include text entered through a chat interface, voice input converted to text using speech recognition, or messages transmitted via an application programming interface (API). The natural language input is not restricted to a fixed vocabulary or grammar and may include incomplete sentences, colloquial expressions, or references implied through conversational context.

The user refers to an entity that initiates interaction with the virtual platform. The user may correspond to a human participant operating a client device, such as a mobile device, desktop computer, console, or wearable device. In some implementations, the user may be represented by a user account, profile, or identifier maintained by the virtual platform. The user may interact with the platform through a graphical interface, conversational audio interface, or other input mechanism capable of capturing natural language input.

The natural language input includes a request, which includes an expression indicating that the user seeks information or content from the virtual platform. In the context of block 202, the request is directed toward obtaining a recommendation. The request may be explicit, such as “recommend a virtual experience,” “suggest me a dinosaur themed activity,” or implicit, such as “I want to try something new today.” The request may include constraints, preferences, or contextual signals embedded within the language, such as references to themes, prior activity, difficulty level, social context, or time availability.

A recommendation includes a selection or ordered set of items generated by the platform in response to the request. The recommendation is produced based on analysis of the natural language input and guides the user toward content (e.g., virtual experiences) available within the platform. A recommendation may include identifiers, titles, descriptions, metadata references, or links associated with the recommended items. In some implementations, the recommendation may be transmitted as part of a conversational response, list, or ranked presentation.

In some implementations, obtaining the natural language input may include receiving the input from a client application associated with the platform and performing preprocessing operations. Preprocessing operations may include normalization, tokenization, language detection, or filtering of unsupported characters. The obtained natural language input may be stored temporarily in memory, logged for later analysis (with user permission), or forwarded to subsequent processing components for intent analysis and preference extraction.

In some implementations, multiple natural language inputs may be obtained across a conversational session. Each input may be associated with a session identifier, timestamp, or conversation state. The natural language input obtained at block 202 may be interpreted in view of prior conversational turns, enabling subsequent processing stages to account for conversational continuity, reference resolution, and evolving user intent. Block 202 is followed by block 204.

At block 204, the natural language input is analyzed to determine a user intent and a number of user preferences. The analysis operates on the natural language input obtained at block 202 and may take into account the content of the input as well as contextual information associated with a conversational session.

In some implementations, the analysis may be performed using one or more artificial intelligence (AI) components configured to process linguistic structure, semantic content, and contextual signals present in the input. In some implementations, the one or more AI components include machine learning models configured to perform natural language understanding operations on the natural language input. Such operations may include, e.g., token-level analysis, phrase segmentation, semantic embedding generation, and intent classification. The AI components may generate vector representations of the natural language input that capture semantic relationships between words and phrases, which are compared against learned representations associated with known intent categories or preference dimensions. The AI components may further evaluate contextual signals such as prior conversational turns, session history, or previously inferred preferences to disambiguate the user intent and refine the set of user preferences determined from the input.

In some implementations, the user intent includes an inferred objective or goal expressed by the user through the natural language input. The user intent may capture what the user is seeking to accomplish within the platform. Examples of user intent include a desire to discover new virtual experiences, a request for experiences similar to previously accessed content, an interest in social or multiplayer activities, or a request constrained by time, difficulty level, theme, computational or network resources, skill level, or other resources (e.g., availability of virtual currency of the virtual platform). The user intent may be explicitly stated in the natural language input or implicitly derived from phrasing, word choice, or conversational context.

In some implementations, determining the user intent may include parsing the natural language input to identify action-oriented phrases, request indicators, and contextual modifiers. For example, phrases such as “show me,” “recommend,” or “I want to try” may be used to identify a recommendation-seeking intent, while additional modifiers such as “with friends,” “short,” or “beginner-friendly” may influence how the intent is interpreted. In some implementations, the analysis may consider multiple candidate intents and select one or more intents based on confidence scores or contextual alignment.

In some implementations, the user preferences include attributes, constraints, and/or tendencies associated with the user that are relevant to selecting recommendations. User preferences may be explicitly stated within the natural language input, such as references to genres, themes, interaction styles, or prior experiences. User preferences may be inferred based on phrasing, emphasis, or references to past activity, such as “something like last time” or “not too intense.” The number of user preferences determined may vary depending on the richness of the input.

In some implementations, determining user preferences may include extracting entities, attributes, or qualifiers from the natural language input and mapping them to preference dimensions recognized by the platform. Examples of preference dimensions include content category, social context, pacing, complexity, or aesthetic style. In some implementations, inferred preferences may be combined with previously stored preference data associated with the user, subject to availability and relevance to the current conversational context.

In some implementations, the analysis may be performed incrementally across multiple conversational turns. The user intent and user preferences determined from a current natural language input may be updated, refined, or overridden based on subsequent inputs. The resulting user intent and number of user preferences may be stored in association with a session state and forwarded to subsequent stages of the method for candidate recommendation generation and ranking.

In some implementations, a jailbreak prevention mechanism is applied to the natural language input to determine whether the input includes adversarial content. The jailbreak prevention mechanism may operate prior to analyzing the natural language input for user intent and prior to candidate recommendation generation. The jailbreak prevention mechanism may analyze the natural language input using multiple transformations. Randomized token dropping may be applied by selectively removing or masking subsets of tokens from the natural language input to produce multiple perturbed versions of the input. Each perturbed version may be evaluated to determine whether the inferred intent or semantic meaning changes in a manner indicative of adversarial manipulation. Consistency across evaluations of the perturbed inputs may be used as an indicator that the natural language input does not include adversarial constructs.

In some implementations, when the jailbreak prevention mechanism determines that the natural language input includes adversarial content, a security operation is performed with respect to the natural language input. The security operation may include suppressing further processing of the natural language input, discarding the input, generating a security event, logging the input for review, or returning a restricted response. When the security operation is performed, subsequent operations including analyzing the natural language input to determine user intent, generating candidate recommendations, generating a ranking, generating refined recommendations, and transmitting recommendations are not performed for the natural language input.

In some implementations, semantic intent analysis may include evaluating the natural language input against learned intent representations or policy-aligned intent categories. The analysis may identify attempts to override constraints, elicit restricted behavior, or manipulate downstream processing logic through indirect phrasing. The results of randomized token dropping and semantic intent analysis may be combined to produce a determination that the natural language input does not comprise adversarial content. The determination may be stored in association with the conversational session and used to gate subsequent processing stages, including candidate recommendation generation, ranking, refinement, and explanation generation. Block 204 is followed by block 206.

At block 206, a set of candidate recommendations is generated based on the user intent and the user preferences. The generation is based on the inferred intent and preferences, and produces a collection of recommendation candidates that are eligible for further evaluation.

In some implementations, the set of candidate recommendations may be generated using one or more AI components configured to search, filter, or score available content based on alignment with the user intent and the user preferences. In some implementations, the one or more AI components include models configured to perform retrieval, matching, and scoring operations over content available within the platform. The AI components may generate semantic representations of the user intent and user preferences and compare those representations against semantic representations associated with available virtual experiences. Based on these comparisons, the AI components may identify candidate recommendations whose attributes, themes, or interaction characteristics align with the inferred intent and preferences. The AI components may further assign preliminary scores to candidate recommendations based on degrees of similarity, relevance signals, or preference alignment, producing intermediate evaluation data that is used to assemble the set of candidate recommendations for subsequent ranking and refinement stages.

The set of candidate recommendations includes a plurality of distinct recommendation entries selected from content available within the platform. Each candidate recommendation may include an identifier associated with a virtual experience, along with associated metadata used during subsequent ranking and refinement stages. Examples of candidate recommendations include individual virtual experiences that match a requested theme, experiences similar to previously accessed content, and/or experiences satisfying constraints expressed in the natural language input, such as duration, interaction mode, or social context.

Generating the set of candidate recommendations may include querying one or more content indexes, catalogs, or data stores using parameters derived from the user intent and the user preferences. The query parameters may include semantic embeddings, keyword representations, categorical attributes, or preference signals extracted from the natural language input. In some implementations, multiple candidate generation strategies may be applied in parallel, with the resulting candidates combined into a single set.

The generated candidate recommendations may include items produced by different retrieval or inference processes. For example, one portion of the set may include candidates identified through similarity comparison with prior user interactions, while another portion may include candidates identified through semantic matching with the natural language input. The combined set may include overlapping candidates, which may be deduplicated prior to subsequent processing.

In some implementations, the size of the set of candidate recommendations may be controlled using predefined thresholds or dynamically adjusted based on characteristics of the natural language input. For example, a broader or less constrained user intent may result in a larger candidate set, while a narrowly specified intent may result in a smaller candidate set. The candidate set may be stored temporarily in memory and forwarded to subsequent stages for ranking and refinement.

In some implementations, the set of candidate recommendations may be associated with intermediate evaluation data generated during candidate selection. Such data may include preliminary relevance scores, similarity measures, or confidence values associated with individual candidates. These intermediate values may be used as inputs to later ranking operations without being directly exposed to the user.

In some implementations, generating the set of candidate recommendations includes invoking a plurality of external tools via application programming interfaces (APIs) to retrieve platform data of the virtual platform associated with available virtual experiences. The external tools may include services or components that provide access to catalogs, indexes, metadata repositories, analytics stores, or availability data maintained by the platform. Individual external tools may be accessed through a defined application programming interface that accepts query parameters derived from the user intent and user preferences and returns data relevant to candidate selection.

In some implementations, invoking the plurality of external tools may include issuing multiple API calls using different query formulations or retrieval strategies. For example, one external tool may be queried to retrieve experiences matching semantic attributes inferred from the natural language input, while another external tool may be queried to retrieve experiences associated with recent trends, user interaction patterns, or content constraints. Block 206 is followed by block 208.

At block 208, a ranking of the set of candidate recommendations is generated using weighted aggregation of evaluation metrics produced by a number of AI models. In some implementations, the ranking includes an ordered arrangement of the candidate recommendations that reflects relative priority among the candidates. The ranking is based on a respective alignment of the candidate recommendations with the inferred user intent and user preferences. The ranking may be represented as an ordered list, a set of scored entries, or a data structure that associates each candidate recommendation with a relative position.

In some implementations, the evaluation metrics include quantitative or categorical values generated by AI models when assessing individual candidate recommendations. Evaluation metrics may include relevance scores, similarity scores, preference alignment scores, novelty indicators, diversity contributions, or constraint satisfaction values. Each evaluation metric may be computed independently by a corresponding AI model based on different input features, representations, or learned parameters. The evaluation metrics may be normalized or scaled prior to aggregation.

In some implementations, weighted aggregation includes combining multiple evaluation metrics into an aggregated value for each candidate recommendation using assigned weights. Each weight includes a value that influences the contribution of a corresponding evaluation metric to the aggregated result. The weights may be predefined, dynamically adjusted, or derived from historical performance data associated with the AI models. Weighted aggregation may be performed using linear combinations, normalized sums, or other deterministic aggregation formulations.

In some implementations, the AI models may include multiple models configured to evaluate candidate recommendations from different perspectives. For example, one AI model may focus on semantic similarity between the user intent and candidate descriptions, while another AI model may focus on preference alignment based on prior interaction data. Each AI model produces evaluation metrics independently, and the metrics are aggregated to reduce reliance on a single evaluation source.

In some implementations, the AI models used to generate evaluation metrics may be trained using different training objectives, datasets, or feature representations. For example, one AI model may be trained primarily on user interaction logs (obtained and used with specific user permission) to capture behavioral similarity patterns, while another AI model may be trained on content metadata to capture thematic or structural similarity. The use of models with different training characteristics enables the aggregated evaluation to incorporate complementary signals derived from distinct data sources.

In some implementations, the AI models may be executed in parallel, with each model receiving a representation of the candidate recommendations and the inferred user intent and preferences as input. The models may operate independently and produce evaluation metrics without direct communication between models. The resulting metrics may be collected and passed to an aggregation component that applies the weighted aggregation logic described at block 208.

In some implementations, the set of AI models used for evaluation may be configurable or extensible. For example, additional models may be introduced to evaluate specific attributes of candidate recommendations, such as temporal relevance, social context alignment, or compatibility with device capabilities. The aggregation may be updated to incorporate evaluation metrics from newly introduced models by assigning corresponding weights, without modifying the overall ranking pipeline structure.

In some implementations, generating the ranking may include computing an aggregated score for each candidate recommendation based on the weighted aggregation of its evaluation metrics. The aggregated scores may be compared to determine relative ranking among the candidates. In some implementations, ties or near ties may be resolved using secondary ranking rules or additional evaluation metrics. The resulting ranking may include a full ranking of all candidate recommendations or a partial ranking of a subset.

In some implementations, the ranking of the set of candidate recommendations is based on one or more of the following: relevance, novelty, diversity, and user-specific constraints. Relevance includes a measure of how closely a candidate recommendation aligns with the inferred user intent and extracted user preferences. Relevance may be determined using semantic similarity values, preference alignment scores, or other evaluation metrics produced by one or more AI models during candidate evaluation. Candidate recommendations with higher relevance values may be assigned higher positions in the ranking.

In some implementations, novelty of a candidate recommendation includes a measure of how distinct the candidate recommendation is relative to content previously interacted with by the user. Novelty may be determined based on prior interaction data, exposure history, or similarity comparisons against previously recommended or selected items. In some implementations, diversity includes a measure of variation across the set of candidate recommendations, such that the ranked output includes candidates that span different categories, attributes, and/or interaction characteristics. In some implementations, user-specific constraints include limitations or conditions inferred from the natural language input or stored user data, such as time availability, interaction mode preferences, or access restrictions. In some implementations. the evaluation metrics corresponding to relevance, novelty, diversity, and user-specific constraints may be combined during the weighted aggregation to influence the final ranking order.

In some implementations, the plurality of AI models includes a plurality of large language models (LLMs). Each LLM may include a neural network model trained to process and generate natural language representations based on learned statistical relationships over textual data. The LLMs may be configured to accept inputs that include natural language input, inferred user intent, user preferences, candidate recommendation descriptors, contextual cues, or intermediate data produced by other processing stages. In some implementations, the same LLM may be utilized to perform various operations described herein, while in other implementations, different operations may be performed by different LLMs (or different versions of the same LLM, e.g., with specific fine-tuning, or with different computational requirements).

In some implementations, the LLMs may be used to perform different computational functions within the recommendation pipeline. For example, one LLM may be used to generate semantic representations of the natural language input for intent and preference analysis, while another LLM may be used to evaluate candidate recommendations by comparing textual descriptions of content against inferred intent representations. Additional LLMs may be used to process contextual cues or to assist in refinement operations by re-evaluating ranked candidates in view of conversational context or historical interaction data.

In some implementations, the LLMs may operate independently and produce evaluation metrics, representations, or refinement signals that are aggregated or combined by other components. Each LLM may use a different prompt structure, parameter configuration, or inference context, enabling the models to contribute complementary perspectives during ranking and refinement.

In some implementations, the plurality of LLMs may be configurable or extensible. Additional LLMs may be introduced to perform specialized evaluation or refinement tasks without altering the overall processing flow. For example, an additional LLM may be incorporated to process longer conversational histories, handle specific content domains, or generate explanation-related signals. The ability to include multiple LLMs enables the recommendation pipeline to adapt to different conversational scenarios and content characteristics while maintaining a consistent operational structure.

In some implementations, weighted aggregation of evaluation metrics includes assigning model-specific weights based on historical evaluation performance of the plurality of AI models. Historical evaluation performance may include measurements derived from prior ranking outcomes, user interaction feedback, selection frequency, engagement duration, or correction events associated with recommendations influenced by each AI model. The historical evaluation performance data may be stored in association with model identifiers and updated over time as additional interaction data becomes available.

In some implementations, assigning model-specific weights may include computing weight values that increase or decrease the influence of evaluation metrics produced by a given AI model during aggregation. For example, an AI model that has historically produced evaluation metrics aligned with subsequent user selections may be assigned a higher weight, while an AI model associated with lower engagement or frequent re-ranking adjustments may be assigned a lower weight. The model-specific weights may be applied during aggregation at block 208 and may be recalculated periodically or dynamically based on updated historical evaluation performance data. Block 208 is followed by block 210.

At block 210, a set of refined recommendations is generated by modifying the ranking of the set of candidate recommendations using contextual cues across the AI models. The refinement operates on the ranking and adjusts ranking or inclusion of candidate recommendations based on additional information beyond the evaluation metrics used for initial ranking. In some implementations, the refined recommendations may be represented as an updated ordered list or scored collection that reflects context-aware adjustments.

In some implementations, contextual cues include signals associated with the current interaction or surrounding environment that influence how candidate recommendations should be prioritized. Contextual cues may include conversational state, recency of user actions, temporal information, session duration, or interaction patterns observed during the current session. For example, a conversational cue indicating that the user is continuing a prior topic may influence refinement by prioritizing candidates related to previously discussed themes.

In some implementations, contextual cues may include historical interaction data associated with the user. Such data may include prior selections, engagement duration, completion status, or frequency of interaction with similar content. For example, a candidate recommendation may be moved higher in the refined ranking if the user previously engaged with similar content for extended periods, or moved lower if similar content was previously abandoned.

In some implementations, contextual cues may include content-specific metadata associated with candidate recommendations. Such metadata may include popularity trends, freshness indicators, availability constraints, or compatibility attributes. For example, a candidate recommendation may be deprioritized if it is temporarily unavailable or elevated if it has recently become accessible or updated within the platform.

In some implementations, the refinement may include applying adjustment functions that modify aggregated scores or relative positions based on contextual cues. The adjustment functions may include additive offsets, multiplicative factors, or rule-based transformations applied to individual candidates. The AI models may evaluate contextual cues independently and produce refinement signals that are combined to determine how the ranking is modified.

In some implementations, generating the set of refined recommendations includes re-evaluating a subset of higher-ranked candidate recommendations using additional contextual attributes derived from metadata associated with virtual experiences represented by the candidate recommendations and inferred user preference signals. The subset of higher-ranked candidate recommendations may include candidates positioned above a predefined rank threshold or candidates whose aggregated scores fall within a specified range. Re-evaluation may be performed to incorporate information that was not fully accounted for during initial ranking, such as updated conversational context or newly available metadata associated with the virtual experiences.

In some implementations, the additional contextual attributes may include attributes obtained from metadata describing characteristics of the virtual experiences, such as category labels, interaction modes, recency indicators, or availability constraints, as well as inferred user preference signals derived from analysis of the natural language input and prior user interaction data. Re-evaluating the subset of candidates may include adjusting scores, modifying relative ranking, or excluding candidates that do not satisfy contextual conditions. The resulting refined recommendations may reflect context-aware prioritization that accounts for both the initial ranking and the additional contextual attributes applied during re-evaluation. Block 210 is followed by block 212.

At block 212, the set of refined recommendations is transmitted to the user. In some implementations, the transmission includes delivering the refined recommendations from the platform to a client interface associated with the user. The transmission may occur after completion of ranking and refinement processing and may include packaging the refined recommendations into a response structure suitable for presentation within a conversational or graphical interface.

In some implementations, transmitting the refined recommendations may include formatting the recommendations into a data representation that can be rendered by a client application. The data representation may include identifiers, ranking information, scores, descriptive text, or metadata associated with each refined recommendation. In some implementations, the data representation may be structured as a message payload, response object, or serialized data structure transmitted over a network connection.

In some implementations, the transmission may be performed using one or more communication protocols supported by the platform and the client device. Examples include transmitting the refined recommendations via a network request-response exchange, a streaming interface, or an event-driven messaging mechanism. The refined recommendations may be transmitted synchronously in response to the natural language input or asynchronously as part of an ongoing conversational session.

In some implementations, the refined recommendations may be transmitted incrementally. For example, a subset of the refined recommendations may be transmitted first, followed by additional recommendations or updates as further processing completes. Incremental transmission may be used to support conversational continuity, progressive disclosure, or interactive refinement based on subsequent user input.

In some implementations, the refined recommendations may be associated with session-related information. Such information may include a session identifier, conversation state, timestamp, or correlation identifier that enables the client application to associate the refined recommendations with the corresponding user request. The association supports multi-turn interactions in which subsequent user input may reference previously transmitted recommendations.

In some implementations, transmitting the refined recommendations may include storing a record of the transmitted recommendations in association with the user or session. The stored record may include the ranking of the refined recommendations, any associated scores, and contextual information present at the time of transmission. The stored record may be used for later analysis, auditing, explanation generation, or to inform subsequent recommendation processing during the same or a later session.

In some implementations, one or more explanations are generated for one or more recommendations in the set of refined recommendations using at least a subset of the plurality of AI models. The explanation generation operates on data produced during prior processing stages, including the user intent, the user preferences, evaluation metrics, aggregated scores, and contextual cues applied during refinement. The explanations may include textual content that describes factors contributing to the inclusion or ranking of a recommendation, such as alignment with expressed preferences, similarity to previously interacted content, or relevance to the conversational context.

In some implementations, generating the one or more explanations may include selecting explanatory attributes associated with a recommendation and assembling those attributes into a structured or unstructured representation suitable for presentation to the user. Different AI models may be used to generate different portions of an explanation, such as identifying salient factors, composing natural language descriptions, or summarizing ranking considerations. The one or more explanations are transmitted to the user together with, or subsequent to, the refined recommendations. The explanations may be transmitted as part of the same response payload as the refined recommendations or as a separate message associated with the same conversational session.

In some implementations, generating the one or more explanations includes identifying and assembling justification signals that describe alignment between the refined recommendations and at least one of the user intent, the plurality of user preferences, or prior interaction data associated with the user. The justification signals may be selected from intermediate data produced during intent analysis, candidate evaluation, ranking, and refinement. Such intermediate data may include inferred intent representations, extracted preference attributes, interaction summaries, and contextual adjustment values applied to individual recommendations.

In some implementations, generating the explanations may include mapping selected justification signals to explanation elements associated with each refined recommendation. For example, a justification signal indicating similarity to prior interactions may be mapped to a corresponding explanation element describing that similarity, while a justification signal derived from an inferred preference may be mapped to an explanation element describing preference alignment. The explanation elements may be composed into a structured explanation or natural language output that associates each refined recommendation with one or more justification signals. The generated explanations may be transmitted to the user together with the refined recommendations or as part of a subsequent conversational response.

In some implementations, the generated one or more explanations are evaluated using an automated explanation assessment prior to transmission to the user. The automated explanation assessment may operate on explanation outputs produced by one or more AI models and may compute one or more explanation quality scores associated with each explanation. The explanation quality scores may be based on measurable attributes of the explanations, including completeness with respect to the refined recommendation, consistency with the inferred user intent and user preferences, and correspondence to intermediate data used during ranking and refinement.

Evaluating the explanations may include comparing explanation elements against stored representations of at least one of user intent, preference attributes, or prior interaction data to verify alignment. The automated explanation assessment may further include detecting missing justification signals, inconsistent statements, or explanations that do not correspond to the refined recommendation ranking. Each explanation quality score may be compared against a threshold. When an explanation quality score fails to meet the threshold, the associated explanation is excluded from transmitting to the user. The explanation quality scores and assessment results may be stored in association with the conversational session and used to control whether and which explanations are transmitted. ranking

In some implementations, excluding an explanation from transmitting includes omitting the explanation from a response payload delivered to the user while still transmitting the associated refined recommendation. In other implementations, excluding the explanation includes transmitting an alternative explanation that satisfies the threshold or transmitting the refined recommendation without explanation content. The exclusion of explanations based on explanation quality scores prevents low-quality or inconsistent explanation content from being presented during a recommendation interaction.

In some implementations, analyzing the natural language input, generating the set of candidate recommendations, generating the ranking, and generating the set of refined recommendations are performed by a plurality of cooperating agents. Each cooperating agent may be instantiated as a separately invocable processing component that receives input data, performs a defined operation, and produces output data for consumption by another agent. The cooperating agents may communicate through shared memory, message passing, or invocation interfaces that enable intermediate results produced by one agent to be provided as input to another agent.

In some implementations, each of the plurality of cooperating agents is configured to execute a different operation within the recommendation pipeline. For example, one agent may process the natural language input to produce representations of user intent and user preferences, another agent may generate candidate recommendations based on those representations, another agent may compute evaluation metrics and generate a ranking, and another agent may apply contextual cues to refine the ranking. The agents may be invoked sequentially, concurrently, or according to a defined execution order, and may be combined or replaced without modifying other agents. Intermediate data produced by the cooperating agents may be retained in association with the conversational session and used for subsequent operations, explanation generation, or auditing.

In some implementations, the techniques described herein are not limited to recommending virtual experiences and may be applied to recommending items available via a platform. An item may include any content, asset, or offering that is accessible through a platform interface and capable of being recommended in response to natural language input. Items may include digital items, physical items, or combinations thereof, and may be presented through a content discovery interface, conversational interface, or other user-facing interface.

In some implementations, obtaining a natural language input from a user includes receiving a request for a recommendation of one or more items available via the platform. The natural language input may express preferences, constraints, or contextual signals related to item categories, attributes, prior interactions, or intended use. Analyzing the natural language input to determine user intent and user preferences may include determining an intent to discover items within one or more categories and extracting preference signals relevant to selecting among available items.

In some implementations, generating candidate recommendations, generating a ranking using weighted aggregation of evaluation metrics produced by a plurality of AI models, and generating refined recommendations using contextual cues may be performed in the same manner described above, with candidate recommendations corresponding to items available via the platform. Evaluation metrics may reflect alignment between the items and the inferred user intent, inferred user preferences, or contextual attributes associated with the items. The refined recommendations may be transmitted to the user as recommended items through the platform interface.

In some implementations, the items available via the platform include digital media items, consumer goods, or interactive content. For example, the techniques described herein may be used to recommend media items such as videos, audio recordings, or textual content; interactive items such as games or applications; or physical goods such as apparel or accessories. The recommendation process may further include generating explanations for recommended items and evaluating explanation quality prior to transmission, as described above, irrespective of item type.

In some implementations, the platform includes an online service, marketplace, catalog, or content aggregation environment through which items are made available. The platform may maintain metadata, availability information, and interaction data associated with items and users. The described techniques may be applied uniformly across different item categories using a common conversational recommendation pipeline, enabling extension of the recommendation functionality without modifying the underlying analysis, ranking, refinement, or explanation assessment operations.

In some implementations, one or more of blocks 202-212 may be performed by one or more server devices, and one or more of blocks 202-212 may be performed by one or more client devices. In some implementations, all of method 200 may be performed by a server device, or by a client device. In some implementations, blocks 202, 210, or 212 may be omitted. In some implementations, one or more of blocks 202-212 may be performed in parallel.

Some implementations described herein may utilize user data, such as conversational input, interaction history associated with prior recommendations, and feedback signals provided by the user during recommendation sessions. In such cases, user data is collected and used subject to user permission and in accordance with applicable privacy regulations. User data, when collected, is limited to data necessary to support recommendation generation, ranking, refinement, explanation generation, and model evaluation. Identifiable user information may be removed or anonymized prior to storage or use in training or evaluating AI models, with retained data restricted to information required for those purposes. Collected data may be retained for a limited duration consistent with the intended use. Users may be provided with controls to manage whether data is collected, how the data is used, and to request deletion of associated data.

In various implementations, the techniques described herein may include combinations of one or more features recited in the claims. For example, in some implementations, a natural language input is obtained from a user, the natural language input including a request for a recommendation of virtual experiences within a virtual platform. The natural language input is analyzed to determine a user intent and a plurality of user preferences, a set of candidate recommendations is generated based on the user intent and the plurality of user preferences, a ranking of the set of candidate recommendations is generated using weighted aggregation of evaluation metrics produced by a plurality of artificial intelligence (AI) models, a set of refined recommendations is generated by modifying the ranking of the set of candidate recommendations using a plurality of contextual cues across the plurality of AI models, and the set of refined recommendations is transmitted to the user.

In some implementations, prior to analyzing the natural language input, detection is performed using a jailbreak prevention mechanism to determine that the natural language input includes adversarial content, the jailbreak prevention mechanism including randomized token dropping and semantic intent analysis. In response to determining that the natural language input includes the adversarial content, a security operation is performed with respect to the natural language input, and the analyzing, generating the set of candidate recommendations, generating the ranking, generating the set of refined recommendations, and transmitting are not performed. In other implementations, generation is performed, via at least a subset of the plurality of AI models, of one or more explanations for one or more recommendations in the set of refined recommendations, and the one or more explanations are transmitted to the user. In still further implementations, both the detection of adversarial content using the jailbreak prevention mechanism and the generation and transmission of the one or more explanations are performed together with the obtaining, analyzing, generating, ranking, refining, and transmitting operations.

In some implementations, generating the one or more explanations includes identifying and assembling justification signals that describe alignment between individual recommendations and at least one of the user intent, the plurality of user preferences, or prior interaction data associated with the user. In some implementations, the generated one or more explanations are evaluated using an automated explanation assessment that computes explanation quality scores prior to transmitting the one or more explanations to the user, wherein at least one explanation associated with an explanation quality score that fails to meet a threshold is excluded from the transmitting. In some implementations, both the identifying and assembling of justification signals and the automated explanation assessment with threshold-based exclusion are performed together with the generation and transmission of the one or more explanations.

In some implementations, the ranking of the set of candidate recommendations is generated based on relevance, novelty, diversity, and user-specific constraints. In some implementations, analyzing the natural language input, generating the set of candidate recommendations, generating the ranking, and generating the set of refined recommendations are performed by a plurality of cooperating agents, with each of the plurality of cooperating agents configured to execute a different one of the analyzing, generating, ranking, or refining operations. In some implementations, generation of the ranking based on relevance, novelty, diversity, and user-specific constraints is combined with execution by the plurality of cooperating agents, while in other implementations only one of these aspects is included.

In some implementations, the plurality of AI models include a plurality of large language models. In some implementations, generating the set of candidate recommendations includes invoking a plurality of external tools via application programming interfaces to retrieve platform data of the virtual platform associated with the virtual experiences. In some implementations, assigning model-specific weights during the weighted aggregation of evaluation metrics is performed based on historical evaluation performance of the plurality of AI models. Any one of these aspects is included individually with the obtaining, analyzing, generating, ranking, refining, and transmitting operations, or is combined together in various groupings.

In some implementations, generating the set of refined recommendations includes re-evaluating a subset of higher-ranked candidate recommendations using additional contextual attributes, the additional contextual attributes including metadata associated with the virtual experiences represented by the candidate recommendations and preference signals inferred from the natural language input and prior user interactions. In some implementations, the re-evaluation using the additional contextual attributes is combined with ranking based on relevance, novelty, diversity, and user-specific constraints. In other implementations, the re-evaluation is combined with execution by a plurality of cooperating agents, with or without inclusion of large language models, invocation of external tools, or assignment of model-specific weights.

In some implementations, the operations include any combination of the jailbreak prevention mechanism, explanation generation and assessment, ranking based on relevance, novelty, diversity, and user-specific constraints, execution by a plurality of cooperating agents, inclusion of large language models, invocation of external tools, assignment of model-specific weights, and re-evaluation of higher-ranked candidate recommendations using additional contextual attributes. Various sub-combinations of these features are applied depending on platform configuration, regulatory requirements, performance constraints, or desired levels of personalization, safety, and transparency, without requiring that all features be present in a single implementation.

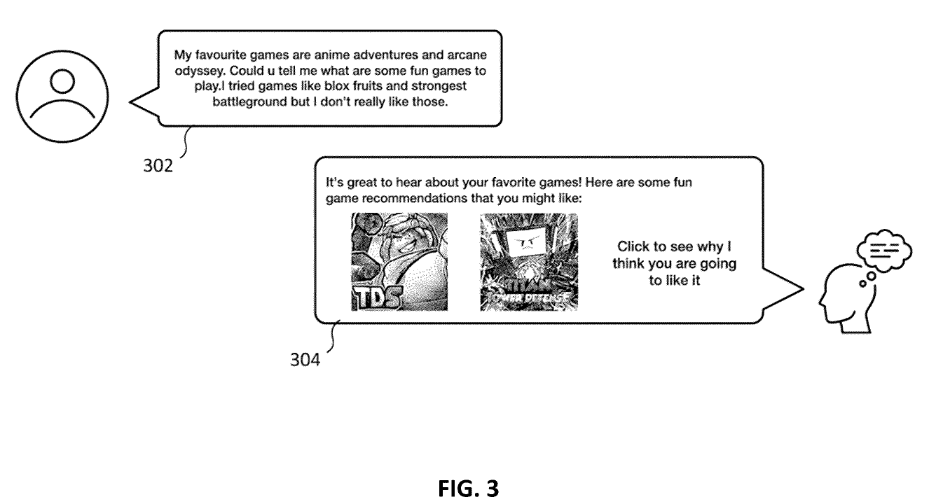

FIG. 3 is a diagram illustrating an example user interaction for providing conversational recommendations of virtual experiences within a virtual platform, in accordance with some implementations. The figure depicts an exchange between a user and a recommendation interface, showing how natural language input is received and how refined recommendations are presented in response. The illustrated interaction corresponds to operations described in connection with obtaining user input, generating recommendations, and transmitting refined outputs to the user.

A natural language input 302 is provided by a user. The natural language input 302 includes free-form text entered by the user expressing preferences, interests, and constraints related to virtual experiences. In the illustrated example, the natural language input 302 conveys thematic interests, references to previously tried experiences, and negative preferences indicating content the user does not wish to receive. The natural language input 302 may be provided through a conversational interface, such as a chat window, voice-to-text input, or another input mechanism supported by the platform.

The natural language input 302 is processed to infer user intent and user preferences, which are used to generate candidate recommendations and refine those recommendations through ranking and contextual evaluation. The output of the processing is reflected in a response 304 generated by the platform and transmitted to the user. The response 304 includes a presentation of recommended virtual experiences selected based on the inferred intent and preferences extracted from the natural language input.

The response 304 may include visual representations associated with individual recommendations, such as thumbnails, icons, or preview images corresponding to recommended virtual experiences. The recommendations may be presented in an ordered arrangement that reflects ranking or prioritization determined by weighted aggregation of evaluation metrics and contextual refinement. The response 304 may include accompanying textual content introducing the recommendations or summarizing why the recommendations are being presented.

In the illustrated example, the response 304 further includes an interactive element that enables the user to request additional information about a particular recommendation. The interactive control may enable the user to view explanation content describing factors that contributed to the recommendation, such as alignment with expressed preferences or similarity to previously referenced experiences. Selection of the interactive control may trigger transmission of explanation data generated by one or more AI models.

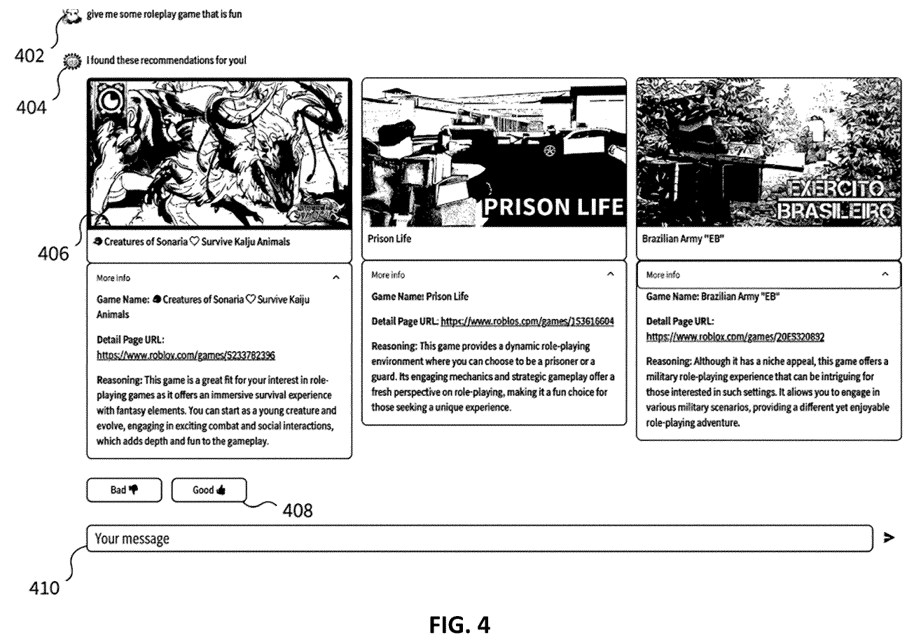

FIG. 4 is a diagram illustrating an example presentation of refined recommendations and associated explanation content within a conversational recommendation interface, in accordance with some implementations. The figure shows how recommendations generated in response to a natural language request are displayed to a user together with supporting information and interactive feedback controls.

Natural language input 402 includes a free-form text message provided by a user within the conversational interface. The natural language input 402 includes a request for recommendations, in the example requesting roleplaying game (RPG)-oriented virtual experiences. The natural language input 402 may be analyzed to determine user intent and user preferences, which are used to generate and refine the recommendations presented in the interface.

Recommendation header 404 includes a system-generated message indicating that recommendation results have been identified and are being presented to the user. The recommendation header 404 may include text confirming that the platform has processed the natural language input 402 and transitioned from input analysis to recommendation delivery. The recommendation header 404 visually separates the user input from the recommendation content.

Recommendation cards 406 include a plurality of recommendation entries presented to the user. Each recommendation card corresponds to a refined recommendation selected from the set of candidate recommendations. The recommendation cards 406 may include visual media associated with each recommended virtual experience, such as preview images or thumbnails, along with textual identifiers such as names or titles. The recommendation cards 406 may be arranged in an ordered layout that reflects ranking determined during weighted aggregation and contextual refinement.

Each recommendation card 406 may further include expandable or supplemental information associated with the corresponding recommendation. Such information may include a detail page link, descriptive metadata, and explanation content describing why the recommendation was selected. The explanation content may include justification signals that describe alignment between the recommendation and the user intent, user preferences, or prior interaction data, and may be generated by one or more AI models.

Feedback controls 408 include user-selectable interface elements that enable the user to provide qualitative feedback regarding the presented recommendations. The feedback controls 408 may enable the user to indicate approval or disapproval of the recommendations, such as by selecting a positive or negative indicator. Feedback received via the feedback controls 408 may be stored in association with the conversational session and used to update historical evaluation performance data or influence subsequent recommendation interactions.

Input field 410 includes an interface component that enables the user to provide additional natural language input following receipt of the recommendations. The input field 410 supports continuation of the conversational session, enabling the user to refine the request, request alternative recommendations, or provide follow-up input.

### Computing Device

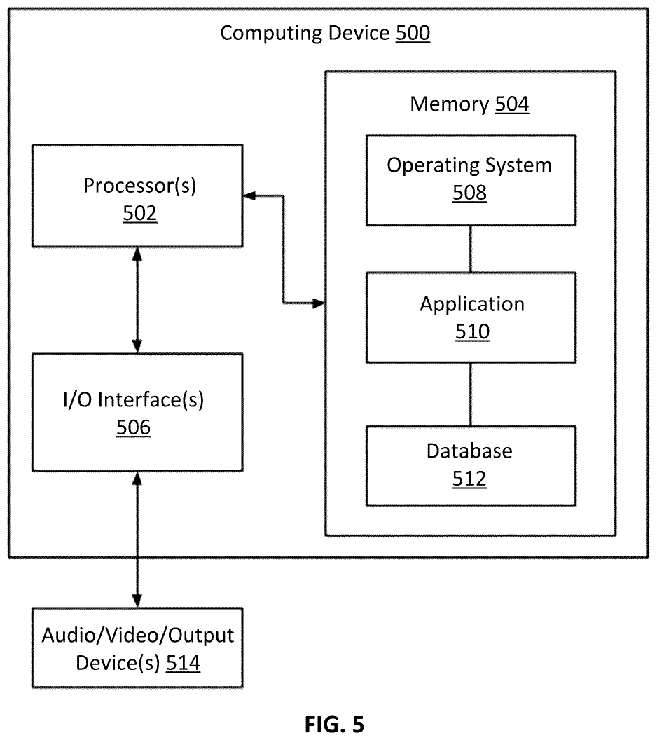

FIG. 5 is a block diagram of an example computing device 500 which may be used to implement one or more techniques described herein. In one example, device 500 may be used to implement a computer device (e.g., 102 and/or 110 of FIG. 1), and perform method implementations described herein. Computing device 500 can be any suitable computer system, server, or other electronic or hardware device that is capable of performing recommendation generation. For example, the computing device 500 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 500 includes a processor 502, a memory 504, input/output (I/O) interface 506, and audio/video input/output devices 514.

Processor 502 can be one or more processors and/or processing circuits to execute program code and control basic operations of the device 500. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “near-real-time”, “offline,” in a “batch mode,” etc. Portions of processing may be performed at different times and at different locations, by different (or the same) processing systems. A computer may be any processor in communication with a memory.

Memory 504 is provided in device 500 for access by the processor 502, and may be any suitable computer-readable or processor-readable storage medium, e.g., random access memory (RAM), read-only memory (ROM), Electrical Erasable Read-only Memory (EEPROM), Flash memory, etc., suitable for storing instructions for execution by the processor, and located separate from processor 502 and/or integrated therewith. Memory 504 can store software operating on the server device 500 by the processor 502, including an operating system 507, one or more applications 510, and a database 512 that may store data used by the components of device 500.

Database 512 may store one or more mechanisms, including user preferences, candidate recommendation data, and configurations for managing multi-agent collaboration in a conversational recommendation environment. In some implementations, database 512 may store information associated with virtual experiences, such as unique identifiers for each experience, metadata describing their attributes and user ratings, and data representing their relevance to specific user intents and preferences. The stored data can include, e.g., historical recommendation records, ranking configurations, and contextual cues used during refinement of candidate recommendations. For example, in a virtual platform, the database may store weighted evaluation metrics and contextual signals that influence the ranking and refinement processes. In some implementations, database 512 may store other data relevant to recommendation management, such as jailbreak detection logs, configurations for weighted aggregation mechanisms, and user interaction histories for improving future recommendations. Applications 510 can include instructions that enable processor 502 to execute the described techniques, such as analyzing user input, ranking and refining recommendations, and generating user-centric explanations. For example, various machine learning models and other models used in described features (e.g., the sets of LLMs used as described herein and in the appendix) can be stored in memory 504 and/or other connected storage devices accessible to processor 502 and/or used via applications 510.

For example, applications 510 can include a module that implements one or more techniques or services described herein, such as analyzing user input to determine intent and preferences, managing weighted aggregation of recommendation metrics, or integrating platform-specific criteria into ranking and refinement processes. Applications 510 can incorporate real-time or near-real-time updates that monitor user interaction histories. The applications may employ various mechanisms to enhance recommendation quality, including refining candidate rankings using contextual cues, detecting and mitigating adversarial inputs, and generating user-centric explanations based on multi-agent collaboration. Database 512 (and/or other connected storage) can store various data used in the described techniques, including user identifiers, historical recommendation records, ranking configurations, and parameters for determining refinement or explanation generation based on specific user behaviors.

Elements of software in memory 504 can alternatively be stored on any other suitable storage location or computer-readable medium. In addition, memory 504 (and/or other connected storage device(s)) can store instructions and data used in the features described herein. Memory 504 and any other type of storage (magnetic disk, optical disk, magnetic tape, or other tangible media) can be considered “storage” or “storage devices.”

I/O interface 506 can provide functions to enable interfacing the server device 500 with other systems and devices. For example, network communication devices, storage devices (e.g., memory and/or data store 120), and input/output devices can communicate via interface 506. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 514 can a variety of devices including a user input device (e.g., a mouse, etc.) that can be used to receive user input, audio output devices (e.g., speakers), and a display device (e.g., screen, monitor, etc.) and/or a combined input and display device, which can be used to provide graphical and/or visual output.

For ease of illustration, FIG. 5 shows one block for each of processor 502, memory 504, I/O interface 506, and software blocks of operating system 508 and virtual experience application 510. The blocks may represent one or more processors or processing circuitries, operating systems, memories, I/O interfaces, applications, and/or software engines. In other implementations, device 500 may not have all of the components shown and/or may have other elements including other types of elements instead of, or in addition to, those shown herein. While the online virtual experience server 102 is described as performing operations as described in some implementations herein, any suitable component or combination of components of online virtual experience server 102, client device 110, or similar system, or any suitable processor or processors associated with such a system, may perform the operations described.

Device 500 can be a server device or client device. Example client devices or user devices can be computer devices including some similar components as the device 500, e.g., processor(s) 502, memory 504, and I/O interface 506. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 514, for example, can be connected to (or included in) the device 500 to display images pre-and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, the particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, blocks, operations, or computations may be presented in a specific order, the order may be changed in different particular implementations. In some implementations, multiple steps or operations shown as sequential in this specification may be performed at the same time.

1. A computer-implemented method comprising:
obtaining a natural language input from a user, the natural language input comprising a request for a recommendation of virtual experiences within a virtual platform;
analyzing the natural language input to determine a user intent and a plurality of user preferences;
generating a set of candidate recommendations based on the user intent and the plurality of user preferences;
generating a ranking of the set of candidate recommendations using weighted aggregation of evaluation metrics produced by a plurality of artificial intelligence (AI) models;
generating a set of refined recommendations by modifying the ranking of the set of candidate recommendations using a plurality of contextual cues across the plurality of AI models; and
transmitting, to the user, the set of refined recommendations.

2. The computer-implemented method of claim 1, further comprising:
prior to analyzing the natural language input, detecting, using a jailbreak prevention mechanism, that the natural language input comprises adversarial content, the jailbreak prevention mechanism comprising randomized token dropping and semantic intent analysis; and
in response to determining that the natural language input comprises the adversarial content, performing a security operation with respect to the natural language input, and wherein the analyzing, generating the set of candidate recommendations, generating the ranking, generating the set of refined recommendations, and transmitting are not performed.

3. The computer-implemented method of claim 1, further comprising:
generating, via at least a subset of the plurality of AI models, one or more explanations for one or more recommendations in the set of refined recommendations; and
transmitting, to the user, the one or more explanations.

4. The computer-implemented method of claim 3, wherein generating the one or more explanations comprises identifying and assembling justification signals that describe alignment between individual recommendations and at least one of: the user intent, the plurality of user preferences, or prior interaction data associated with the user.

5. The computer-implemented method of claim 4, further comprising:
evaluating the generated one or more explanations using an automated explanation assessment that computes explanation quality scores prior to transmitting the one or more explanations to the user, wherein at least one explanation associated with an explanation quality score that fails to meet a threshold is excluded from the transmitting.

6. The computer-implemented method of claim 1, wherein the ranking of the set of candidate recommendations is based on one or more of the following: relevance, novelty, diversity, and user-specific constraints.

7. The computer-implemented method of claim 1, wherein analyzing the natural language input, generating the set of candidate recommendations, generating the ranking, and generating the set of refined recommendations are performed by a plurality of cooperating agents, and wherein each of the plurality of cooperating agents is configured to execute a different one of the analyzing, generating, ranking, or refining operations.

8. The computer-implemented method of claim 1, wherein the plurality of AI models comprise a plurality of large language models (LLMs).

9. The computer-implemented method of claim 1, wherein generating the set of candidate recommendations comprises invoking a plurality of external tools via application programming interfaces to retrieve platform data of the virtual platform associated with the virtual experiences.

10. The computer-implemented method of claim 1, wherein the weighted aggregation of evaluation metrics comprises assigning model-specific weights based on historical evaluation performance of the plurality of AI models.

11. The computer-implemented method of claim 1, wherein generating the set of refined recommendations comprises re-evaluating a subset of higher-ranked candidate recommendations using additional contextual attributes, the additional contextual attributes including metadata associated with the virtual experiences represented by the candidate recommendations and preference signals inferred from the natural language input and prior user interactions.

12. A computing device comprising:
one or more processors; and
memory coupled to the one or more processors with instructions stored thereon that, when executed by the one or more processors, cause the one or more processors to perform or control performance of operations comprising:
obtaining a natural language input from a user, the natural language input comprising a request for a recommendation of virtual experiences within a virtual platform;
analyzing the natural language input to determine a user intent and a plurality of user preferences;
generating a set of candidate recommendations based on the user intent and the plurality of user preferences;
generating a ranking of the set of candidate recommendations using weighted aggregation of evaluation metrics produced by a plurality of artificial intelligence (AI) models;
generating a set of refined recommendations by modifying the ranking of the set of candidate recommendations using a plurality of contextual cues across the plurality of AI models; and
transmitting, to the user, the set of refined recommendations.

13. The computing device of claim 12, wherein the instructions cause the one or more processors to perform or control performance of further operations comprising:
prior to analyzing the natural language input, detecting, using a jailbreak prevention mechanism, that the natural language input comprises adversarial content, the jailbreak prevention mechanism comprising randomized token dropping and semantic intent analysis; and
in response to determining that the natural language input comprises the adversarial content, performing a security operation with respect to the natural language input, and wherein the analyzing, generating the set of candidate recommendations, generating the ranking, generating the set of refined recommendations, and transmitting are not performed.

14. The computing device of claim 12, wherein the instructions cause the one or more processors to perform or control performance of further operations comprising:
generating, via at least a subset of the plurality of AI models, one or more explanations for one or more recommendations in the set of refined recommendations; and
transmitting, to the user, the one or more explanations.

15. The computing device of claim 14, wherein generating the one or more explanations comprises identifying and assembling justification signals that describe alignment between individual recommendations and at least one of: the user intent, the plurality of user preferences, or prior interaction data associated with the user.

16. The computing device of claim 15, wherein the instructions cause the one or more processors to perform or control performance of a further operation comprising:
evaluating the generated one or more explanations using an automated explanation assessment that computes explanation quality scores prior to transmitting the one or more explanations to the user, wherein at least one explanation associated with an explanation quality score that fails to meet a threshold is excluded from the transmitting.

17. The computing device of claim 12, wherein the ranking of the set of candidate recommendations is based on one or more of the following: relevance, novelty, diversity, and user-specific constraints.

18. The computing device of claim 12, wherein analyzing the natural language input, generating the set of candidate recommendations, generating the ranking, and generating the set of refined recommendations are performed by a plurality of cooperating agents, and wherein each of the plurality of cooperating agents is configured to execute a different one of the analyzing, generating, ranking, or refining operations.

19. The computing device of claim 12, wherein the plurality of AI models comprise a plurality of large language models (LLMs).

20. A non-transitory computer-readable medium with instructions stored thereon that, when executed by a processor, cause the processor to perform or control performance of operations comprising:
obtaining a natural language input from a user, the natural language input comprising a request for a recommendation of virtual experiences within a virtual platform;
analyzing the natural language input to determine a user intent and a plurality of user preferences;
generating a set of candidate recommendations based on the user intent and the plurality of user preferences;
generating a ranking of the set of candidate recommendations using weighted aggregation of evaluation metrics produced by a plurality of artificial intelligence (AI) models;
generating a set of refined recommendations by modifying the ranking of the set of candidate recommendations using a plurality of contextual cues across the plurality of AI models; and
transmitting, to the user, the set of refined recommendations.
